(19) United States
(12) Patent Application Publication
(10) Pub. No.: US 2008/0174526 A1
(43) Pub. Date: Jul. 24, 2008

(54) Plasma display and driving method thereof

(76) Inventor: Jung-Soo An, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/006,627

(22) Filed: Jan. 4, 2008

(30) Foreign Application Priority Data
Jan. 19, 2007 (KR) 10-2007-0006167

(51) Int. Cl. G09G 3/28

(52) U.S. Cl. 345/68

(57) ABSTRACT

In a plasma display of the present invention, a VscH voltage is applied to a scan electrode during an address period, and a −Vs voltage is initially applied to the scan electrode during a sustain period. Subsequently, during the sustain period, a sustain pulse alternately having a Vs voltage and the −Vs voltage is applied by performing an energy recovery operation. Then, a hard switching generated during an early stage of the sustain period may be reduced.

### CROSS-REFERENCE TO RELATED APPLICATION

This application claims priority to and the benefit of Korean Patent Application No. 10-2007-0006167 filed in the Korean Intellectual Property Office on Jan. 19, 2007, the entire contents of which are incorporated herein by reference.

### BACKGROUND

1. Field

The present invention relates to a plasma display.

2. Description of the Related Technology

A plasma display uses a plasma display panel (PDP) that uses plasma generated by a gas discharge process to display characters or images. The PDP includes, depending on its size, more than several scores to millions of pixels arranged in a matrix.

In general, when using the plasma display, a frame is divided into a plurality of subfields each having a time weight. Gray scales are expressed by a combination of subfields whereby a display operation is generated. Turn-on/turn-off cells (i.e., cells to be turned on or off) are selected during an address period of each subfield, and a sustain discharge operation is performed on the turn-on cells so as to display an image during a sustain period.

Specifically, a sustain pulse is alternately applied to scan and sustain electrodes during the sustain period to perform a sustain discharge. In order to perform the operation, a scan driving board for driving the scan electrodes and a sustain driving board for driving the sustain electrodes are separately needed.

Accordingly, a sustain pulse alternately having a Vs voltage and −Vs voltage is applied only to the scan electrode while a reference voltage is applied to the sustain electrode, during the sustain period to reduce a size of the sustain driving board.

Since a capacitive load exists in the panel due to the respective electrodes, a reactive power is required to generate the sustain pulse. Accordingly, a driving circuit of the plasma display includes an energy recovery circuit for recovering and reusing the reactive power.

However, since an energy recovery operation may not be performed when the Vs voltage is initially applied to the scan electrode during the sustain period, a hard switching is generated in a transistor which transmits the Vs voltage to the scan electrode when the Vs voltage is initially applied to the scan electrode during the sustain period.

Power loss may occur and an element may be deteriorated by the hard switching operation, and substantial electromagnetic interference (EMI) may occur.

The above information disclosed in this Background section is only for enhancement of understanding of the background and therefore may contain information that does not form the prior art that is already known in this country to a person of ordinary skill in the art.

### SUMMARY OF CERTAIN INVENTIVE ASPECTS

One aspect is a method of driving a plasma display including a plurality of first electrodes and a plurality of second electrodes, the method including during an address period, applying a first voltage to a first electrode selected from the plurality of first electrodes, and applying a second voltage that is higher than the first voltage to the first electrodes not selected from the plurality of first electrodes, and during a sustain period, applying a third voltage to the plurality of second electrodes while decreasing a voltage at the plurality of first electrodes from the second voltage to a fourth voltage, and applying a sustain pulse alternately having the fourth voltage and a fifth voltage that is higher than the fourth voltage to the plurality of first electrodes.

Another aspect is a plasma display, including a plasma display panel (PDP) including a plurality of first electrodes and a plurality of second electrodes, and a driver configured to, during a sustain period, apply a sustain pulse having a second voltage that is higher than a first voltage and a third voltage that is lower than the first voltage to the plurality of first electrodes while the first voltage is applied to the plurality of second electrodes, where the driver is further configured to apply a fourth voltage to a first electrode not selected from the plurality of first electrodes during an address period, and to apply the sustain pulse to the plurality of first electrodes after decreasing a voltage at the plurality of first electrodes from a fourth voltage to a third voltage during a sustain period.

Another aspect is a plasma display, including a plasma display panel (PDP) including a plurality of first electrodes and a plurality of second electrodes, and a driver configured to during an address period, apply a first voltage to a first electrode selected from the plurality of first electrodes, change the voltage of the selected first electrode from the first voltage to a second voltage, the second voltage being less than the first voltage, and during a sustain period, apply a sustain pulse having at least the second voltage and a third voltage to the selected first electrode.

### BRIEF DESCRIPTION OF THE DRAWINGS

FIG. 1 shows an exploded perspective view of a plasma display according to one embodiment.

FIG. 2 shows a schematic view of a plasma display panel (PDP) according to an embodiment.

FIG. 3 shows a top plan view of a chassis base according to an embodiment.

FIG. 4 shows a diagram representing driving waveforms of the plasma display according to an embodiment.

FIG. 5 shows a diagram of a driving circuit according to an embodiment.

FIG. 6 shows a signal timing diagram of the scan electrode driving circuit according to an embodiment.

FIG. 7 shows a diagram representing an operation of the scan electrode driving circuit according to signal timing shown in FIG. 6.

FIG. 8 shows a diagram representing driving waveforms of the plasma display according to an embodiment.

### DETAILED DESCRIPTION OF CERTAIN INVENTIVE EMBODIMENTS

In the following detailed description, only certain embodiments been shown and described, simply by way of illustration. As those skilled in the art would realize, the described embodiments may be modified in various ways, without departing from the spirit or scope of the present invention. Accordingly, the drawings and description are to be regarded as illustrative in nature. Like reference numerals generally designate like elements throughout the specification.

Throughout this specification and the claims that follow, when it is described that an element is “coupled” to another element, the element may be “directly coupled” to the other element or may be “electrically coupled” to the other element through a third element. In addition, unless explicitly described to the contrary, the word “comprise” and variations such as “comprises” or “comprising,” will be understood to imply the inclusion of stated elements but not the exclusion of any other elements.

A plasma display according to an embodiment and a driving method will now be described.

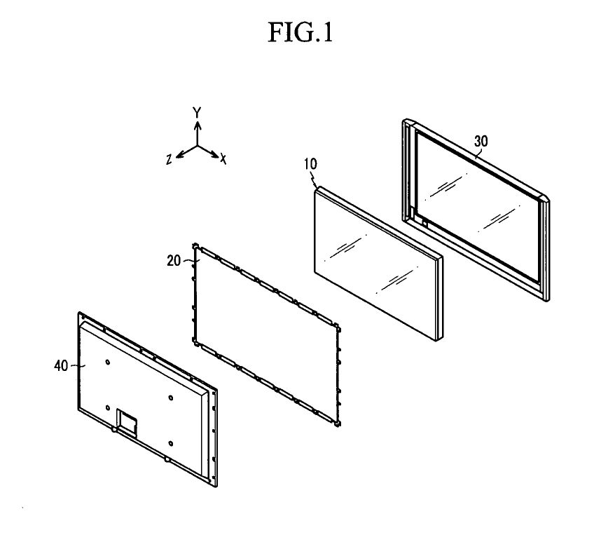

A configuration of the plasma display according to the embodiment will be described with reference to FIG. 1 to FIG. 3.

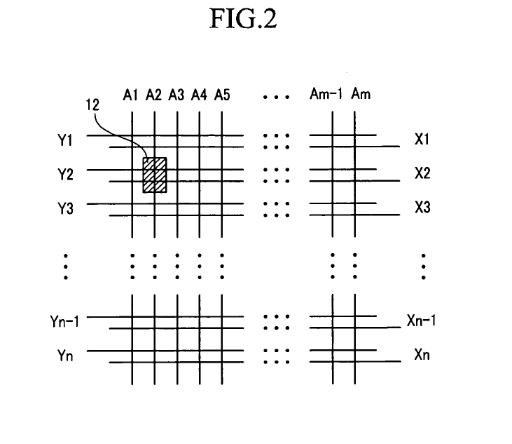

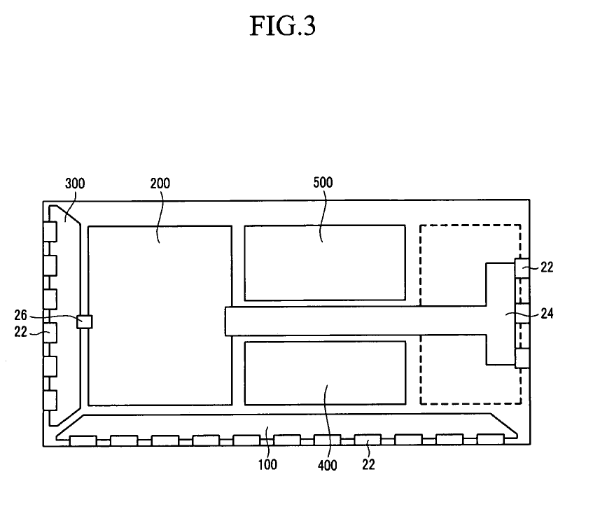

FIG. 1 shows an exploded perspective view of the plasma display according to the embodiment, FIG. 2 shows a schematic view of a plasma display panel (PDP) according to the embodiment, and FIG. 3 shows a top plan view of a chassis base according to the embodiment of the present invention.

As shown in FIG. 1, the plasma display includes a plasma display panel (PDP) 10, a chassis base 20, a front case 30, and a rear case 40. The chassis base 20 is attached to the PDP 10 on a side opposite the image display side of the plasma display panel 10. While being respectively disposed to the front of the PDP 10 and the rear of the chassis base 20, the front and rear cases 30 and 40 are respectively combined to the front of the PDP 10 and the rear of the chassis base 20 to form a plasma display.

As shown in FIG. 2, the PDP 10 includes a plurality of address electrodes A1 to Am (hereinafter referred to as “A electrodes”) extending in a vertical direction and pairs of scan electrodes Y1 to Yn (hereinafter referred to as “Y electrodes”) and sustain electrodes X1 to Xn (hereinafter referred to as “X electrodes”) each extending in a horizontal direction. The sustain electrodes X1 to Xn are formed in respective correspondence to the scan electrodes Y1 to Yn. The Y electrodes Y1 to Yn and the X electrodes X1 to Xn are disposed to cross the A electrodes A1 to Am. A discharge space is formed at each of the regions where the A electrodes A1 to Am cross the X and Y electrodes (X1 to Xn and Y1 to Yn) and the discharge space forms a discharge cell (hereinafter referred to as “cell”) 12. It is to be noted that the construction of the PDP is only an example, and panels having different structures, to which a driving waveform to be described later can be applied.

Referring to FIG. 3, the chassis base 20 includes boards 100, 200, 300, 400, and 500 for driving the PDP 10. The address buffer board 100 is formed on one of upper and lower sides of the chassis base 20. The plasma display performing a single driving operation is exemplified in FIG. 3, and the address buffer board 100 is respectively disposed on both upper and lower sides when a dual driving operation is performed. The address buffer board 100 receives an address driving control signal from an image processing and controlling board 400 and applies a voltage for selecting a turn-on cell to the respective address electrodes A1 to Am.

A scan driving board 200 is provided on the left of the chassis base 20, and is coupled to a scan buffer board 300 through a connection member 26 including a conductive pattern or a cable, and the scan buffer board 300 is electrically coupled to the Y electrodes Y1 to Yn through a flexible printed circuit (FPC) 22. In addition, the scan driving board 200 is electrically coupled to the X electrodes X1 to Xn through a connection member 24 formed to be longer than the connection member 26 and the FPC 22. Further, the scan driving board 200 receives a driving signal from the image processing and controlling board 400 to apply a driving voltage to the Y electrodes Y1 to Yn and the X electrodes X1 to Xn. The scan buffer board 300 applies a voltage for sequentially selecting the Y electrodes Y1 to Yn, to the Y electrodes Y1 to Yn during the address period. It is illustrated that the scan driving board 200 and the scan buffer board 300 are provided on the left of the chassis base 20 in FIG. 3, but they may be provided on the right of the chassis base 20, or in other places. In addition, the scan buffer board 300 and the scan driving board 200 may be integrated.

The image processing and controlling board 400 receives an external video signal, generates control signals for driving the A electrodes A1 to Am and the Y and X electrodes Y1 to Yn and X1 to Xn, and respectively applies them to the address buffer board 100 and the scan driving board 200.

The image processing and controlling board 400 and a power supply board 500 may be provided on the center of the chassis base 20. The power supply board 500 supplies power for driving the plasma display.

The address buffer board 100, the scan driving board 200, and the scan buffer board 300 form a driver for driving the A, Y, and X electrodes, the image processing and controlling board 400 forms a controller for controlling the driver, and the power supply board 500 forms a power source unit for supplying power to the driver and the controller.

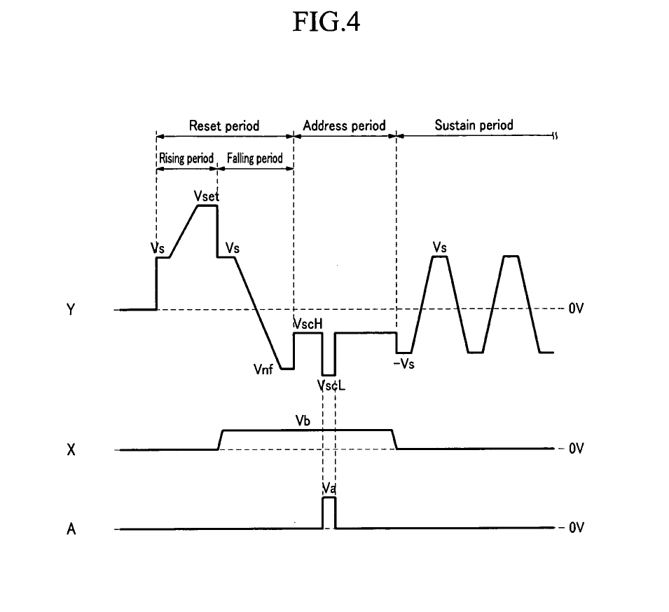

Driving waveforms of the plasma display according to one embodiment will be described with reference to FIG. 4. For convenience of description, the driving waveform applied to the Y, X, and A electrodes forming one cell will be described.

FIG. 4 shows a diagram representing the driving waveform according to one embodiment.

In FIG. 4, it is illustrated that the voltage at the Y electrode is increased in a ramp pattern. As shown in FIG. 4, during a rising period of the reset period, while a reference voltage (0V in FIG. 4) is applied to the X and A electrodes, a voltage at the Y electrode is gradually increased from a Vs voltage to a Vset voltage. As a result, a weak discharge is generated between the Y electrode and the X electrode and between the Y electrode and the A electrode. While the voltage at the Y electrode increases, (−) wall charges are formed in the Y electrode, and (+) wall charges are formed in the X and A electrodes. When a voltage at an electrode increases as shown in FIG. 4, a weak discharge is generated in a cell, and a wall voltage in the cell is formed such that a sum of an external voltage and the wall voltage in the cell to is at least a discharge firing voltage. This topic is discussed in a U.S. Pat. No. 5,745,086 by Weber. Since all cells are initialized during the reset period, the Vset voltage is high enough to generate a discharge in a cell in every condition.

During the falling period of the reset period, while the X electrode and the A electrode are respectively maintained at a Vb voltage and a reference voltage, the voltage at the Y electrode is gradually decreased from the Vs voltage to a Vnf voltage. As a result, the weak discharge is generated between the Y electrode and the X electrode and between the Y electrode and the A electrode while the voltage at the Y electrode decreases, and the (−) wall charges formed in the Y electrode and the (+) wall charge formed in the X electrode and the A electrode are eliminated. Generally, a voltage of (Vnf−Vb) is set close to a discharge firing voltage between the Y and X electrodes. Accordingly, the wall voltage between the Y and X electrodes is close to 0V, and the cell in which an address discharge is not generated during the address period may be prevented from being discharged during the sustain period.

During the address period, to select a turn-on cell, while the X electrode is maintained at the Vb voltage, a scan pulse having a negative VscL voltage and address pulse having Va voltage are respectively applied to the Y and A electrodes. As a result, the address discharge is generated in the cell formed by the A electrode by applying the Va voltage, by the Y electrode applying the VscL voltage, and in the cell by the Y electrode by applying the VscL voltage and X electrode applying Vb voltage, the (+) wall charges are formed in the Y electrode, and the (−) wall charges are formed in the A electrode and the X electrode. In addition, a negative VscH voltage that is higher than the VscL voltage is biased at the Y electrode that is not selected, and the reference voltage 0V is applied to the A electrode in a turn-off cell (i.e., a cell to be turned off).

To perform the operation during the address period, the scan buffer board 300 selects the Y electrode to which the scan pulse having the VscL voltage is applied among the Y electrodes Y1 to Yn. For example, the Y electrode may be selected in a vertical direction in the single driving method. When one Y electrode is selected, the address buffer board 100 selects a turn-on discharge cell among the discharge cells formed by the corresponding Y electrode. That is, the address buffer board 100 selects a cell to which the address pulse having the Va voltage is applied among the A electrodes A1 to Am.

During the sustain period, while a voltage at the X electrode is maintained at the reference voltage 0V, a −Vs voltage is initially applied to the Y electrode, and a sustain pulse alternatively having the Vs voltage and −Vs voltage is applied to the Y electrode. Because the VscH voltage is a negative voltage, the hard switching may be further reduced when the −Vs voltage is initially applied to the Y electrode, compared to when the Vs voltage is initially applied to the Y electrode.

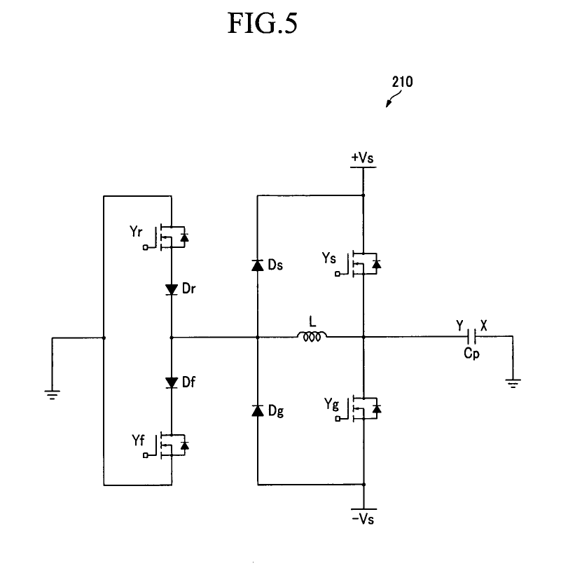

A configuration of a driving circuit 210 for generating the driving waveform of the sustain period is described with reference to FIG. 5.

FIG. 5 shows a diagram of the driving circuit according to an embodiment. In FIG. 5, for better understanding and ease of description, only one Y electrode is shown, and one Y electrode and a capacitive component that is formed by the corresponding X electrode are described as a panel capacitor Cp. In addition, a driving circuit 210 for applying the scan pulse to the scan electrode during the sustain period is illustrated. The driving circuit 210 can be formed in the scan driving board 400.

As shown in FIG. 5, the driving circuit 210 includes transistors Yr, Yf, Ys, and Yg, diodes Dr, Df, Ds, and Dg, and an inductor L. In FIG. 5, the transistors Yr, Yf, Ys, and Yg are illustrated as n-channel field effect transistors (particularly, n-channel metal oxide semiconductor (NMOS) transistors), and body diodes may be formed from sources to drains of the transistors Yr, Yf, Ys, and Yg. Rather than using the NMOS transistor, another transistor that performs a similar function may be used as the transistors Yr, Yf, Ys, and Yg. In FIG. 5, while the respective transistors Yr, Yf, Ys, and Yg are respectively illustrated as single transistors, the respective transistors Yr, Yf, Ys, and Yg may be formed by a plurality of transistors coupled in parallel. As shown in FIG. 5, the transistor Ys is coupled between a power source Vs for supplying the Vs voltage and the Y electrode, and the transistor Yg is coupled between a power source −Vs and the Y electrode. A first terminal of the inductor L is coupled to the Y electrode, and a second terminal thereof is coupled to an anode of the diode Ds and a cathode of the diode Dg. A cathode of the diode Ds is coupled to the power source Vs, and an anode of the Dg is coupled to the power source −Vs. The second terminal of the inductor L is also coupled to a cathode of the diode Dr and an anode of the diode Df, an anode of the diode Dr is coupled to a source of the transistor Yr, and a cathode of the diode Df is coupled to a drain of the transistor Yf. A drain of the transistor Yr and a source of the transistor Yf are coupled to a ground terminal.

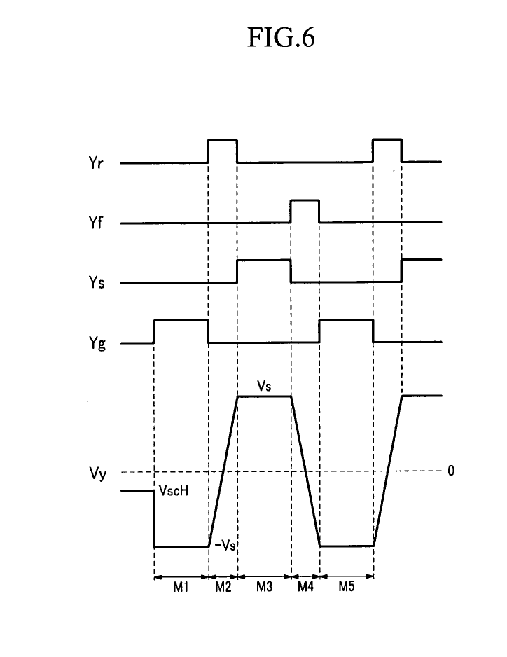

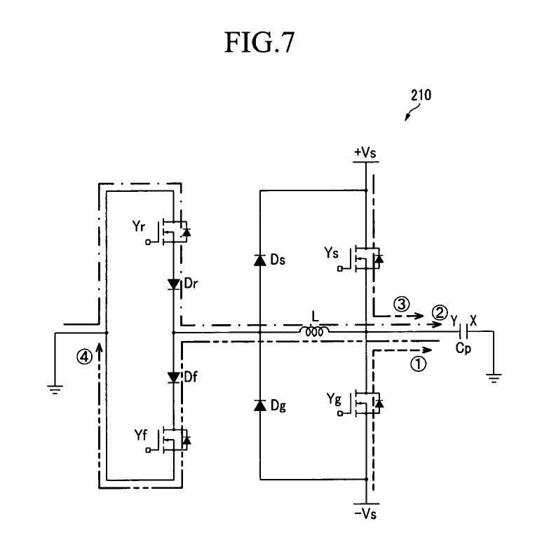

The diode Ds and Dg clamp the second voltage of inductor L and the diode Dr forms a path for increasing the voltage at the Y electrode if it is too low, and the diode Df forms a path for decreasing the voltage at the Y electrode if it is too high. At this time, if transistors Yr and Yf do not have a body diode, diodes Dr and Df can be not included. Furthermore, the position of diode Dr and transistor Yr can be changed, and a position of diode Df and transistor Yf can be changed. FIG. 6 shows a signal timing diagram of the driving circuit 210 shown in FIG. 5, and FIG. 7 shows a diagram representing an operation of the driving circuit 210 according to the signal timing shown in FIG. 6. The operation of the scan electrode driving circuit 210 will be described with reference to FIG. 6 and FIG. 7.

It is assumed that the VscH voltage is applied to the Y electrode during the address period before the sustain period.

As shown in FIG. 6 and FIG. 7, at a mode 1 M1, the transistor Yg is turned on, and the −Vs voltage is applied to the Y electrode (path \textcircled{1} in FIG. 7). During the sustain period, the −Vs voltage is initially applied to the Y electrode. Then, because the VscH voltage applied to the Y electrode before the mode 1 M1 is a negative voltage, the hard switching may be further reduced when the −Vs voltage is initially applied to the Y electrode, compared to when the Vs voltage is initially applied to the Y electrode.

At a mode 2 M2, the transistor Yg is turned off, the transistor Yr is turned on, and a resonance is generated through a path \textcircled{2} of the transistor Yr, the diode Dr, the inductor L, and the panel capacitor Cp. Because of the resonance, the voltage at the Y electrode is increased from the −Vs voltage to the Vs voltage.

At a mode 3 M3, the transistor Yr is turned off, the transistor Ys is turned on, and the Vs voltage is applied to the Y electrode through a path \textcircled{3} shown in FIG. 7.

At a mode 4 M4, the transistor Ys is turned off, the transistor Yf is turned on, and the resonance is generated through a path \textcircled{4} of the panel capacitor Cp, the inductor L, the diode Df, and the transistor Yf. Because of the resonance, the voltage at the Y electrode is decreased from the Vs voltage to the −Vs voltage.

At a mode 5 M5, the transistor Yf is turned off, the transistor Yg is turned on, and the −Vs voltage is applied to the Y electrode through the path \textcircled{1} in FIG. 7.

Subsequently, during the sustain period, the mode 2 M2 through the mode 5 M5 are repeatedly performed a number of times corresponding to weight values of the corresponding subfield, where the sustain pulse alternately has the −Vs voltage and the Vs voltage, and may be applied to the Y electrode.

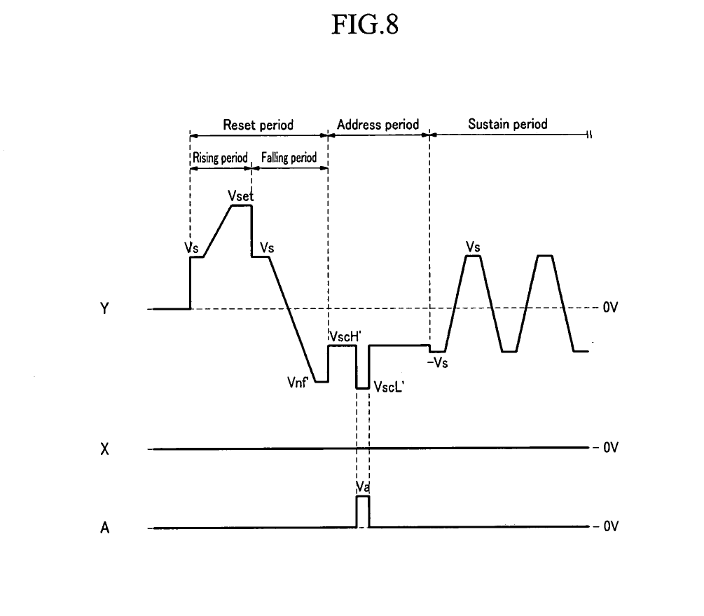

FIG. 8 shows a diagram representing driving waveforms of the plasma display according to another embodiment.

As shown in FIG. 8, the driving waveforms are the same as those of the earlier described embodiment except that the reference voltage 0V is applied to the X electrode, and Vnf′, VscL′, and VscH′ voltages that are reduced by Vb voltage when compared to the Vnf, VscL, and VscH voltages described above.

In this case, since a voltage difference between Y electrode and X electrode is the same as a voltage difference between Y electrode and X electrode in the first embodiment, during the corresponding periods, the operation and a effect also substantially the same as that described above.

In the second embodiment, because the reset period, the address period, and the sustain discharge may be performed by the driving waveform applied to the Y electrode while the X electrode is biased to the reference voltage 0V, one board may be used. Accordingly, area of the driving boards 100, 200, 300, 400, and 500 in the chassis base 20 is reduced, and a circuit cost of the PDP may be reduced.

In addition, because the voltage at the Y electrode is reduced by Vb voltage when compared to that of the first embodiment, in the falling period of reset period and the address period, an absolute value of voltage difference between VscH′ voltage and −Vs voltage becomes smaller than an absolute value of voltage difference between VscH voltage and −Vs voltage. Accordingly, the hard switching may be further reduced when the −Vs voltage is initially applied to the Y electrode, when compared to the first embodiment.

According to one embodiment, because sustain pulses having Vs voltage and −Vs voltage are applied to the scan electrode after −Vs voltage is applied to the scan electrode during the sustain period, the hard switching may be reduced during the early stage of the sustain period.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of driving a plasma display comprising a plurality of first electrodes and a plurality of second electrodes, the method comprising:
during an address period, applying a first voltage to a first electrode selected from the plurality of first electrodes, and applying a second voltage that is higher than the first voltage to the first electrodes not selected from the plurality of first electrodes; and
during a sustain period, applying a third voltage to the plurality of second electrodes while decreasing a voltage at the plurality of first electrodes from the second voltage to a fourth voltage, and applying a sustain pulse alternately having the fourth voltage and a fifth voltage that is higher than the fourth voltage to the plurality of first electrodes.

2. The method of claim 1, wherein the third voltage is higher than the second voltage.

3. The method of claim 2, wherein the second voltage is a negative voltage.

4. The method of claim 1, wherein the sustain pulse is applied using an inductor coupled to the plurality of second electrodes.

5. The method of claim 1, wherein the third voltage is applied to the plurality of second electrodes during the address period.

6. The method of claim 1, wherein a sixth voltage that is higher than the third voltage is applied to the plurality of second electrodes during the address period.

7. A plasma display, comprising:
a plasma display panel (PDP) comprising a plurality of first electrodes and a plurality of second electrodes; and
a driver configured to, during a sustain period, apply a sustain pulse having a second voltage that is higher than a first voltage and a third voltage that is lower than the first voltage to the plurality of first electrodes while the first voltage is applied to the plurality of second electrodes,
wherein the driver is further configured to apply a fourth voltage to a first electrode not selected from the plurality of first electrodes during an address period, and to apply the sustain pulse to the plurality of first electrodes after decreasing a voltage at the plurality of first electrodes from a fourth voltage to a third voltage during a sustain period.

8. The plasma display of claim 7, wherein the driver comprises an inductor coupled to the plurality of first electrodes, and is configured to increase the voltage at the plurality of first electrodes from the third voltage to the second voltage or to decrease the voltage at the plurality of first electrodes from the second voltage to the third voltage with the inductor.

9. The plasma display of claim 8, wherein the first voltage is higher than the fourth voltage.

10. The plasma display of claim 9, wherein the fourth voltage is a negative voltage.

11. The plasma display of claim 7, wherein the driver applies the first voltage to the second electrode during the address period.

12. The plasma display of claim 7, wherein the driver applies a voltage that is higher than the first voltage to the second electrode during the address period.

13. A plasma display, comprising:
a plasma display panel (PDP) comprising a plurality of first electrodes and a plurality of second electrodes; and
a driver configured to:
during an address period, apply a first voltage to the plurality of first electrodes;
change the voltage of the plurality of first electrodes from the first voltage to a second voltage, the second voltage being less than the first voltage; and
during a sustain period, apply a sustain pulse to the plurality of first electrodes by alternately applying the second voltage and a third voltage to the first electrode.

14. The plasma display of claim 13, wherein the difference between the first and second voltages is less than the difference between the first and third voltages.

15. The plasma display of claim 13, wherein the first and second voltages are negative voltages.

16. The plasma display of claim 15, wherein the third voltage is a positive voltage.

17. The plasma display of claim 13, wherein the driver is further configured to apply a fixed voltage to a second electrode, the second electrode corresponding to the selected first electrode.

18. The plasma display of claim 17, wherein the fixed voltage is substantially a ground voltage.

19. The plasma display of claim 13, wherein the second and third voltages have opposite polarity and substantially the same magnitude relative to ground.

20. The plasma display of claim 13, wherein the driver is further configured to alternately apply the second and third voltages to the first electrode during the sustain period.
